(19) United States
(12) Patent Application Publication
(10) Pub. No.: US 2026/0233600 A1
(43) Pub. Date: Aug. 13, 2026

(54) TANK STRAP ASSEMBLY WITH SLIDABLE BRACKET

(71) Applicant: Norma U.S. Holding LLC, Auburn Hills, MI (US)

(72) Inventors: David Reyes Lopez, Cd. Juarez (MX); Julia A. Vang, Shelby Township, MI (US); Jason Stewart, Sterling Heights, MI (US); Jason E. Dendel, Sterling Heights, MI (US)

(21) Appl. No.: 19/052,494

(22) Filed: Feb. 13, 2025

(51) Int. Cl. B60K 15/07

(52) U.S. Cl. CPC B60K 15/07

(57) ABSTRACT

A tank strap assembly supports a position of a fuel tank to a tank frame. An alternative fuel such as hydrogen fuel can be stored in the fuel tank. Applications of use include semi-trailer trucks and other commercial vehicles, among many other possibilities. The tank strap assembly is designed and constructed to accommodate physical expansion of the fuel tank that can occur during a filling and refilling action when the alternative fuel is delivered to the fuel tank. To accommodate fuel tank expansion, the tank strap assembly includes a slidable bracket. The slidable bracket is mounted to the tank frame. The slidable bracket can move in a longitudinal direction relative to the tank frame upon filling of the fuel tank and concomitant expansion thereof.

### TECHNICAL FIELD

This disclosure relates generally to alternative fuel tank constructions for vehicles, and more particularly to tank strap assemblies equipped in alternative fuel tank installations.

### BACKGROUND

Use of alternative fuel sources such as hydrogen fuel for vehicles is increasing. Semi-trailer trucks and other commercial vehicles, as well as sport utility vehicles (SUVs), trucks, and passenger cars, are among the potential applications of use. Alternative fuel tanks store alternative fuels therein prior to being delivered for power generation. The fuel tanks are typically mounted in place in installation. Tank strap assemblies can be employed for mounting the fuel tanks. But when the fuel tanks are filled with the alternative fuels for filling and refilling purposes, the fuel tanks themselves often undergo physical expansion. Accommodating the physical expansion in some way can help maintain the mounting.

### SUMMARY

In an embodiment, a tank strap assembly may include a band, a band bracket, a tightening mechanism, and a slidable bracket. The band bracket can be mounted to a tank frame, and is connected with the band. The tightening mechanism is situated at the band, and is used for tightening the tank strap assembly. The tightening mechanism includes a bolt. The slidable bracket is connected with the band bracket. The slidable bracket can be mounted to the tank frame, and can be moved in a longitudinal direction with respect to the tank frame.

In an embodiment, a tank strap assembly may include a band, a band bracket, a tightening mechanism, and a slidable bracket. The band bracket can be mounted to a tank frame, and is connected with the band. The band bracket can be moved in a longitudinal direction with respect to the tank frame. The tightening mechanism is situated at the band, and is used for tightening the tank strap assembly. The tightening mechanism includes a bolt. The slidable bracket can be moved in the longitudinal direction with respect to the tank frame. Movement is by way of one or more wall openings and by way of an extension that is received in the wall opening(s). The wall opening(s) and extension serve to provide guided slidable movement of the slidable bracket with respect to the tank frame in the longitudinal direction.

In an embodiment, a tank strap assembly may include a first band segment and a second band segment, a band bracket, a tightening mechanism, an elastic pad, and a slidable bracket. The band bracket can be mounted to a tank frame, and is connected with the first band segment and is connected with the second band segment. The tightening mechanism is situated between the first band segment and the second band segment. The tightening mechanism includes a bolt. The elastic pad is located inwardly of the first band segment and second band segment, and is located inwardly of the band bracket. The slidable bracket is connected with the band bracket, and can be mounted to the tank frame. The slidable bracket includes a mount plate and a mount wall. The mount plate has one or more holes, and the mount wall has one or more slots. A bolt extends through the hole(s) and through the slot(s). The mount wall can be slidably moved in a longitudinal direction with respect to the tank frame and with respect to the mount plate.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 depicts an embodiment of a tank frame assembly;

FIG. 2 is an enlarged view of an embodiment of a non-slidable tank strap assembly used in the tank frame assembly;

FIG. 3 shows a rear view of the non-slidable tank strap assembly;

FIG. 4 is a perspective view of the non-slidable tank strap assembly;

FIG. 5 is an enlarged view of an embodiment of a tank strap assembly with sliding capabilities;

FIG. 6 shows a rear view of the tank strap assembly of FIG. 5;

FIG. 7 is a perspective view of the tank strap assembly of FIG. 5;

FIG. 8 is an enlarged view of an embodiment of a tightening mechanism of the tank strap assembly of FIG. 5;

FIG. 9 is a perspective view of an embodiment of a slidable bracket of the tank strap assembly of FIG. 5;

FIG. 10 is another perspective view of the slidable bracket of FIG. 9;

FIG. 11 is yet another perspective view of the slidable bracket of FIG. 9;

FIG. 12 is a perspective view of another embodiment of a tank strap assembly with sliding capabilities;

FIG. 13 is a perspective view of an embodiment of a slidable bracket of the tank strap assembly of FIG. 12;

FIG. 14 is another perspective view of the slidable bracket of FIG. 12; and

FIG. 15 is yet another perspective view of the slidable bracket of FIG. 12.

### DETAILED DESCRIPTION

Embodiments of a tank strap assembly 10 are detailed in this description and depicted in the figures. The tank strap assembly 10 supports a position of a fuel tank 12 to a tank frame 14. The fuel tank 12 can be an alternative fuel tank 16 that stores an alternative fuel such as hydrogen fuel. Unlike past tank straps, the tank strap assembly 10 has a slidable bracket 18 that enables sliding movement of the tank strap assembly 10 in installation and use, while maintaining proper support of the fuel tank 12. The sliding movement serves to accommodate, and account for, physical expansion of the fuel tank 12 that has been shown to occur during a filling and refilling action of the fuel tank 12 with hydrogen fuel. Applications of use can include semi-trailer trucks and other commercial vehicles, as well as sport utility vehicles (SUVs), trucks, and passenger cars, among other possibilities; still, non-automotive applications are a possibility, such as marine applications and aerospace applications, as examples. Overall, a more effective and efficient accommodation of fuel tank expansion is furnished via the tank strap assembly 10. Still, a particular embodiment of the tank strap assembly 10 may exhibit only one, or a combination of, the advancements set forth herein, none of the advancements, or yet other advancements that go unmentioned.

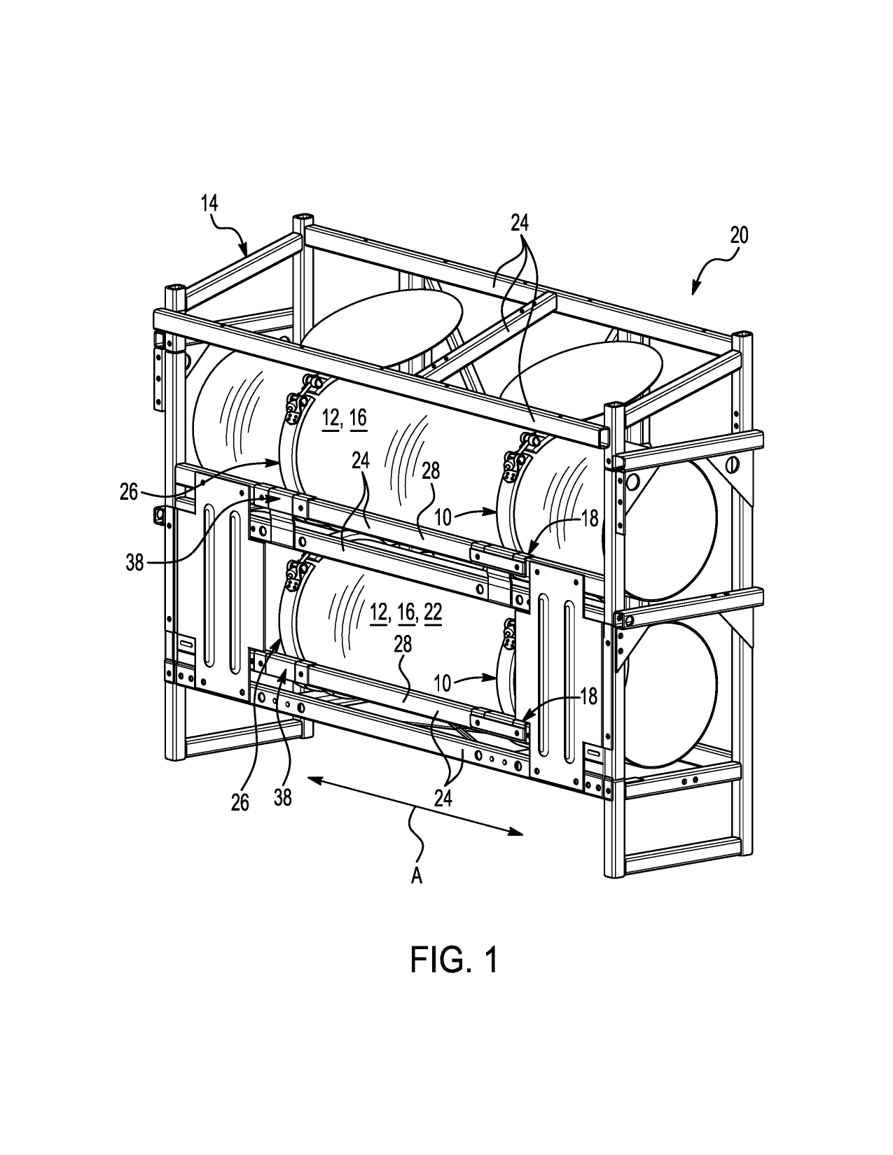

With reference now to FIG. 1, an embodiment of a tank frame assembly 20 is depicted. The tank frame assembly 20 can have various designs, constructions, and components in various embodiments, depending in part or more upon the application. In FIG. 1, the tank frame assembly 20 is intended for assembly and installation with a semi-trailer truck application. The alternative fuel tank 16 and a second alternative fuel tank 22 are carried by the tank frame assembly 20. The alternative fuel tanks 16, 22 hold hydrogen fuel and, in this regard, are hydrogen fuel tanks; still, other alternative fuel types are possible in other embodiments. The alternative fuel tank 16 and the second alternative fuel tank 22 are cylindrical in shape; in this regard, as used herein the terms axial, radial, and circumferential — as well as their grammatical variations — are with respect to the cylindrical shape and also with respect to a circular shape of the tank strap assembly 10. Furthermore, the tank frame assembly 20 includes the tank frame 14. The tank frame 14 is made-up of a multitude of frame structures including frame bars 24. Lastly, according to this embodiment, the tank frame assembly 20 includes the tank strap assembly 10 and a second tank strap assembly 26. Each of the alternative fuel tank 16 and the second alternative fuel tank 22 are supported by a single tank strap assembly 10 that has sliding movement capabilities, and by a single second tank strap assembly 26 that lacks sliding movement capabilities and is hence non-slidable. In this embodiment, the single tank strap assembly 10 and single second tank strap assembly 26 are spaced and distanced apart from each other — one towards one end of the associated tank, and another towards the opposite end.

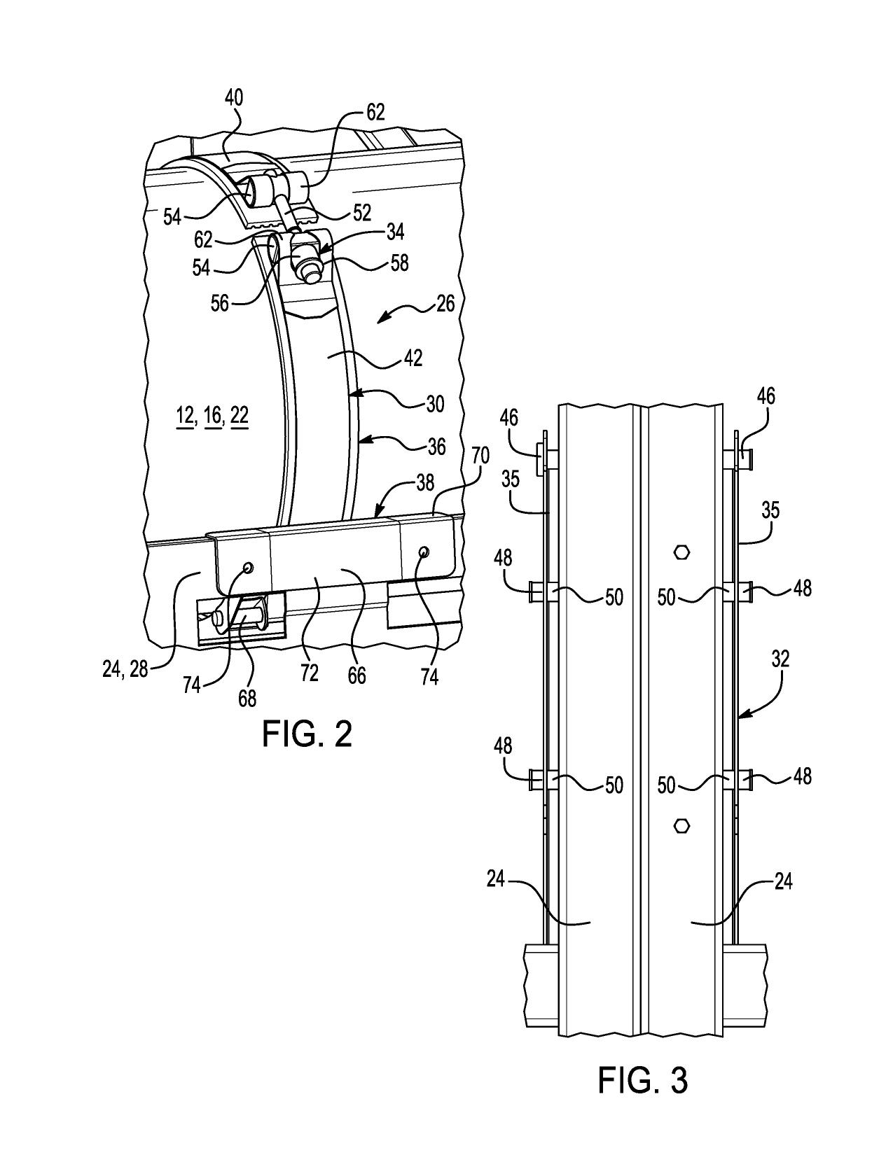

The second tank strap assembly 26 helps support the positions of the alternative fuel tanks 16, 22 at the tank frame 14. The second tank strap assembly 26 can have various designs, constructions, and components in various embodiments. With reference now to FIGS. 2, 3, and 4, in this embodiment the second tank strap assembly 26 is situated circumferentially around the alternative fuel tanks 16, 22, and braced by the tank frame 14. Dissimilar to the tank strap assembly 10, the second tank strap assembly 26 is non-slidable in a longitudinal direction A (FIG. 1) with respect to the tank frame 14; in other words, the second tank strap assembly 26 is longitudinally fixed with the tank frame 14. The longitudinal direction A is established by a longitudinal and lengthwise axis of the alternative fuel tanks 16, 22. The longitudinal direction A, per this embodiment, is also in-line with a longitudinal and lengthwise extent of horizontally-arranged working frame bars 28 to which non-slidable brackets (introduced below) of the second tank strap assembly 26 are mounted. Referring again to FIGS. 2, 3, and 4, the second tank strap assembly 26 includes a (second) band 30, a (second) band bracket 32, a (second) tightening mechanism 34, an elastic pad 36, and a non-slidable bracket 38. In this embodiment, as will be evident from subsequent descriptions, the second tank strap assembly 26 and tank strap assembly 10 share certain components in their designs and constructions, but this is not necessary and in other embodiments the components of the second tank strap assembly 26 and tank strap assembly 10 could differ relative to each other.

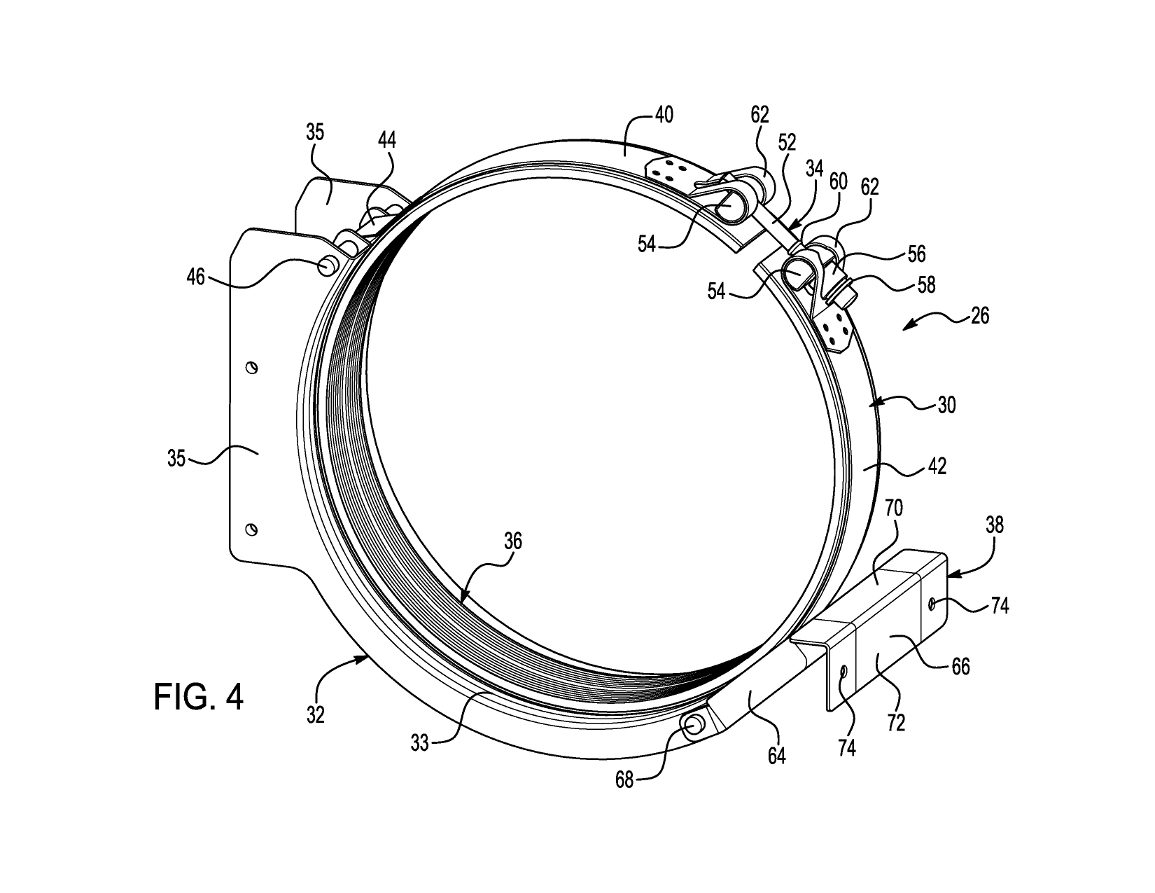

The band 30, according to this embodiment, is made-up of a first band segment 40 and a second band segment 42; still, in other embodiments the band could have more, less, and/or different components. The first and second band segments 40, 42 can be composed of a metal material. The first and second band segments 40, 42 extend partially around a circumference of the alternative fuel tanks 16, 22. The first band segment 40 has a first connection with the band bracket 32, and the second band segment 42 has a second connection with the band bracket 32. The first and second connections can take different forms in different embodiments. In the embodiment of the figures, the first and second connections are in the form of pin-and-loop connections. With particular reference now to FIG. 4, the first band segment 40 has a looped end 44 wrapped around a pin 46. The looped end 44 is formed by bending a section of the first band segment 40 back onto itself and welding it in place. The pin 46 can be in the form of a bolt, as an example. The pin 46 extends through the looped end 44 and through holes residing in the band bracket 32, establishing the first connection therebetween. The first band segment 40 can pivot about the pin 46. The second connection, while less visible in FIG. 4, exhibits a similar construction.

Further, the band bracket 32 is mounted to the tank frame 14 and mounted particularly to vertically-arranged frame bars 24 (FIG. 3). The band bracket 32 can be composed of a metal material. In this embodiment, the mounting is carried out via pins 48 and spacers 50. The pins 48 extend through openings residing in the vertically-arranged frame bars 24 and extend through the spacers 50, and also extend through openings residing in the band bracket 32. The pins 48 can be in the form of bolts, as an example. The spacers 50 prevent movement of the band bracket 32 in the longitudinal direction A. The band bracket 32, according to this embodiment, has a main arcuate portion 33 for receiving the elastic pad 36 and for receiving the alternative fuel tanks 16, 22, and has a pair of mount side walls 35 for straddling the vertically-arranged frame bars 24 upon mounting. The openings reside in the mount side walls 35 for receipt of the pins 48.

Referring to FIGS. 2 and 4, the tightening mechanism 34 is situated at the band 30 — in this embodiment, situated at the first and second band segments 40, 42 — and is used for tightening and loosening the second tank strap assembly 26 and for tightening and loosening the first and second band segments 40, 42 about the alternative fuel tanks 16, 22. The tightening mechanism 34 can have various designs, constructions, and components in various embodiments. According to this embodiment, the tightening mechanism 34 has a bolt 52, a pair of convex bars 54, a spacer 56, spring washers 58, and an o-ring 60; still, in other embodiments the tightening mechanism could have more, less, and/or different components. The bolt 52 extends through the convex bars 54, through the spacer 56, through the spring washers 58, and through the o-ring 60. The bolt 52 can be threaded over part of its shank, and can have a head. In an example, the bolt 52 can be an M12 screw. The convex bars 54 are held in place via bearing loops 62 of the first and second band segments 40, 42. The bearing loops 62 are formed by bending sections of the first and second band segments 40, 42 back onto themselves and welding them in place. Internal threads can reside in openings of the convex bars 54 for engagement with threads of the bolt 52. The spacer 56 serves to lengthen the useful lifetime of the spring washers 58, and the spring washers 58 serve to compensate for any aging and decompression that could be experienced over use of the elastic pad 36 to help ensure an intended support of the alternative fuel tanks 16, 22. Lastly, the o-ring 60 serves to keep the bolt 52 within one of the convex bars 54, preventing it from inadvertent and unwanted dislodgement.

Furthermore, in this embodiment of the second tank strap assembly 26, the elastic pad 36 is located radially inwardly of the band 30 and first and second band segments 40, 42, and located radially inwardly of the band bracket 32. The elastic pad 36 makes direct contact with the underlying alternative fuel tanks 16, 22 in installation, rather than the band 30 and band bracket 32 making direct contact themselves. In the axial direction, the elastic pad 36 can have an axial extent greater than that of the band 30 and the first and second band segments 40, 42, whereby axial end portions of the elastic pad 36 project beyond axial ends of the band 30 and the first and second band segments 40, 42. In a somewhat similar manner in the circumferential direction, the elastic pad 36 has circumferential end portions that project circumferentially beyond the bearing loops 62 of the first and second band segments 40, 42 in order to preclude direct contact from the tightening mechanism 34 with the alternative fuel tanks 16, 22. For seating of the elastic pad 36 with the band 30 and first and second band segments 40, 42 and with the band bracket 32, an adhesive can reside on a radially outwardly surface of the elastic pad 36. The elastic pad 36 can be composed of a rubber material such as an ethylene propylene diene monomer (EPDM) rubber material; still, other types of materials are possible.

The non-slidable bracket 38 can have various designs, constructions, and components in various embodiments. With reference to FIGS. 2 and 4, in this embodiment the non-slidable bracket 38 is mounted to the tank frame 14 and is particularly mounted to the horizontally-arranged working frame bars 28. The mounting prevents movement of the non-slidable bracket 38 in the longitudinal direction A and with respect to the tank frame 14 and with respect to the working frame bars 28. The non-slidable bracket 38 is composed of a metal material, and has a pair of bracket legs 64 and a mount wall 66. The bracket legs 64 and mount wall 66 make-up a unitary construction of the non-slidable bracket 38. The bracket legs 64 have a connection with the band bracket 32. The connection coincides with the second connection established between the second band segment 42 and the band bracket 32. The connection can take different forms in different embodiments. In this embodiment, a pin 68 extends through openings in the bracket legs 64 and extends through openings in the band bracket 32, establishing the connection therebetween. The pin 68 is a shared component and is employed for the second connection too and extends through the accompanying looped end of the second band segment 42. The pin 68 can be in the form of a bolt, as an example. The non-slidable bracket 38 can pivot about the pin 68 with respect to the band bracket 32.

The mount wall 66 has a shape and construction to partially complement that of the working frame bars 28 for surface-to-surface placement therebetween. In this embodiment, the mount wall 66 has a first wall 70 and a second wall 72 that are orthogonally-configured relative to each other to correspond with confronting walls of the working frame bars 28. The mount wall 66 is placed on top of the working frame bars 28 in assembly and installation, as shown in FIG. 2. Once in place, the mount wall 66 can be bolted in place to the working frame bars 28 via holes 74 residing in the mount wall 66. As a consequence of this mounting, the non-slidable bracket 38 is longitudinally fixed with the working frame bars 28 and fixed with the tank frame 14. The mount wall 66, and in turn the non-slidable bracket 38, is unable to slidably move in the longitudinal direction A relative to the working frame bars 28 and relative to the tank frame 14.

It has been observed that the alternative fuel tanks 16, 22 can experience a certain amount of physical expansion amid a filling and refilling action of alternative fuel in the alternative fuel tanks 16, 22. The physical expansion occurs with hydrogen fuel and in hydrogen fuel tanks like the alternative fuel tanks 16, 22, and could also occur with other alternative fuel types. The physical expansion can occur in the longitudinal direction A with respect to the tank frame 14 and in an axial direction with respect to the longitudinal and lengthwise axis of the alternative fuel tanks 16, 22. Moreover, the physical expansion can occur in a lateral direction that is orthogonally-arranged relative to the longitudinal direction A and in a radial direction with respect to the alternative fuel tanks 16, 22. If unaccounted for, the physical expansion could compromise the supported position of the alternative fuel tanks 16, 22 and/or could compromise the storing capabilities of the alternative fuel within the alternative fuel tanks 16, 22.

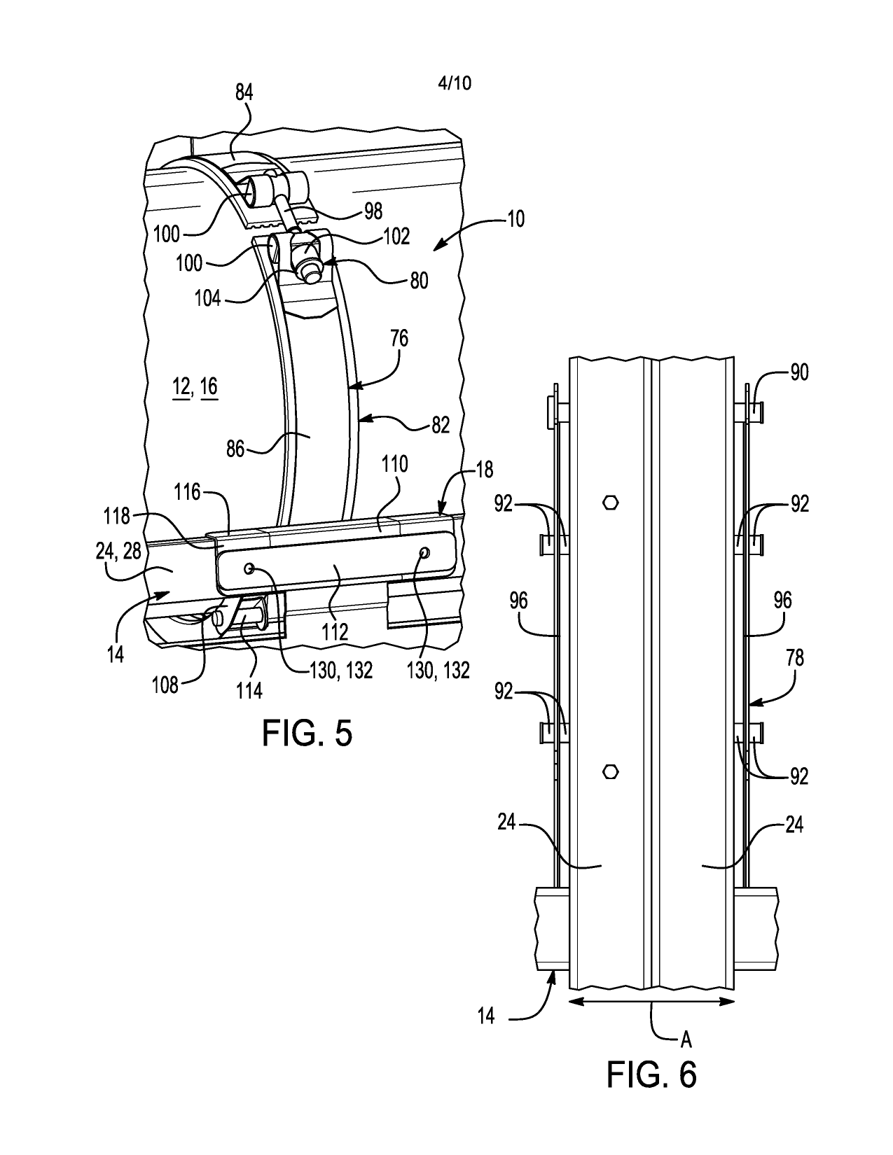

The tank strap assembly 10 has been designed and constructed to furnish proper support of the alternative fuel tanks 16, 22 at the tank frame 14 and also to accommodate and account for the physical expansion of the alternative fuel tanks 16, 22 in the longitudinal direction A and axial direction, as well as in the lateral direction and radial direction, should such expansion occur. The tank strap assembly 10 can have various designs, constructions, and components in various embodiments. With reference to FIGS. 5, 6, and 7, in this embodiment the tank strap assembly 10 is situated circumferentially around the alternative fuel tanks 16, 22 and braced by the tank frame 14. The tank strap assembly 10 is slidable and moveable in the longitudinal direction A with respect to the tank frame 14. The quantity of slidable movement in the longitudinal direction A can correspond to the anticipated physical expansion of the alternative fuel tanks 16, 22 in the longitudinal direction A. The tank strap assembly 10 includes a band 76, a band bracket 78, a tightening mechanism 80, an elastic pad 82, and the slidable bracket 18. Certain of these components are similar to corresponding components of the second tank strap assembly 26 set forth above; in these cases, descriptions may be abridged with reference to the tank strap assembly 10 but still equally applicable to the tank strap assembly 10.

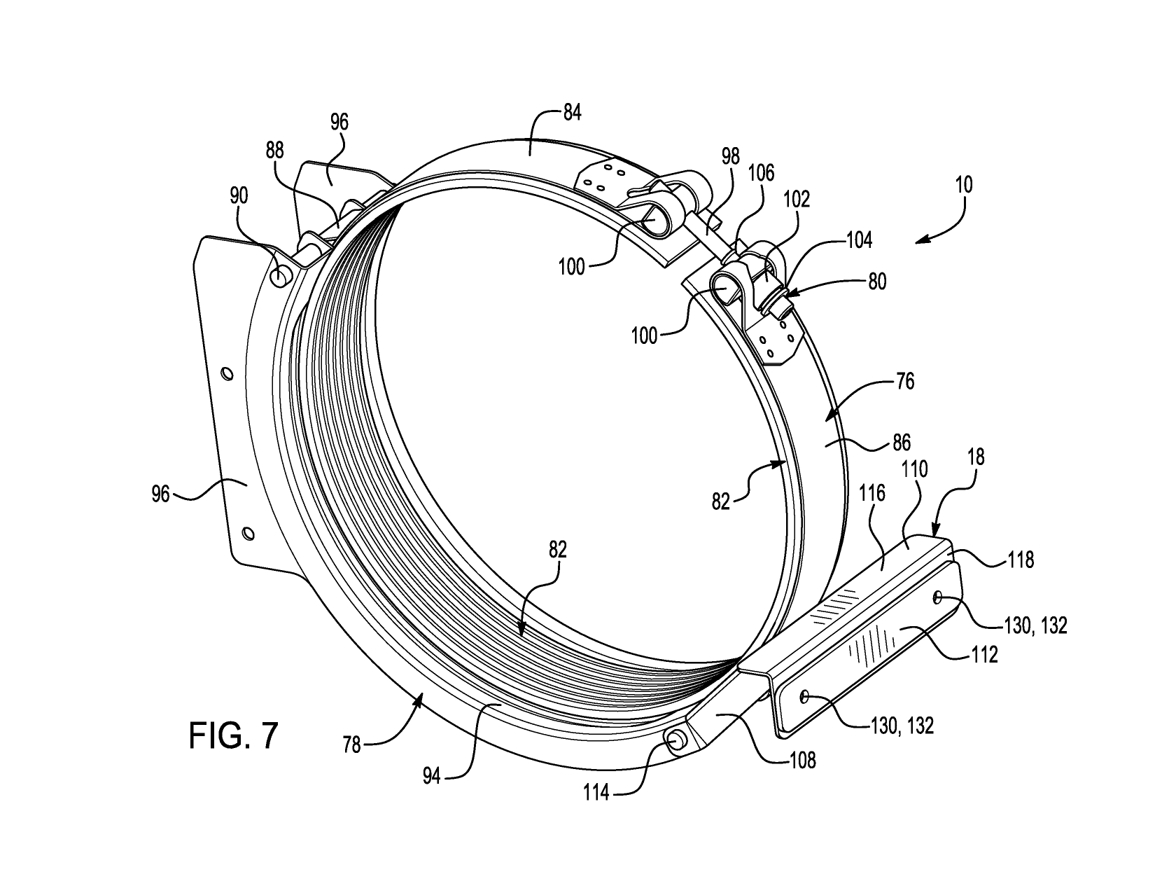

The band 76, per this embodiment, is made-up of a first band segment 84 and a second band segment 86; still, in other embodiments the band could have more, less, and/or different components. As before, the first band segment 84 has a first connection with the band bracket 78, and the second band segment 86 has a second connection with the band bracket 78. The first and second connections can take different forms in different embodiments. In the embodiment of FIGS. 5, 6, and 7, the first and second connections are in the form of pin-and-loop connections. With particular reference now to FIG. 7, the first band segment 84 has a looped end 88 wrapped around a pin 90. The second connection, while less visible in FIG. 7, exhibits a similar construction. Further, the band bracket 78 is mounted to the tank frame 14 and mounted particularly to vertically-arranged frame bars 24 (FIG. 6). In this embodiment, the mounting is carried out via pins 92. The pins 92 extend through openings residing in the vertically-arranged frame bars 24 and extend through openings residing in the band bracket 78. The pins 92 can be in the form of bolts, as an example. Dissimilar to the second tank strap assembly 26, the band bracket 78 of the tank strap assembly 10 is able to move in the longitudinal direction A (the previous spacers are absent in the tank strap assembly 10). Side-to-side longitudinal movement of the band bracket 78 is piloted and guided via the pins 92. The band bracket 78, according to this embodiment, has a main arcuate portion 94 for receiving the elastic pad 82 and for receiving the alternative fuel tanks 16, 22, and has a pair of mount side walls 96 for straddling the vertically-arranged frame bars 24 upon mounting. The openings reside in the mount side walls 96 for receipt of the pins 92.

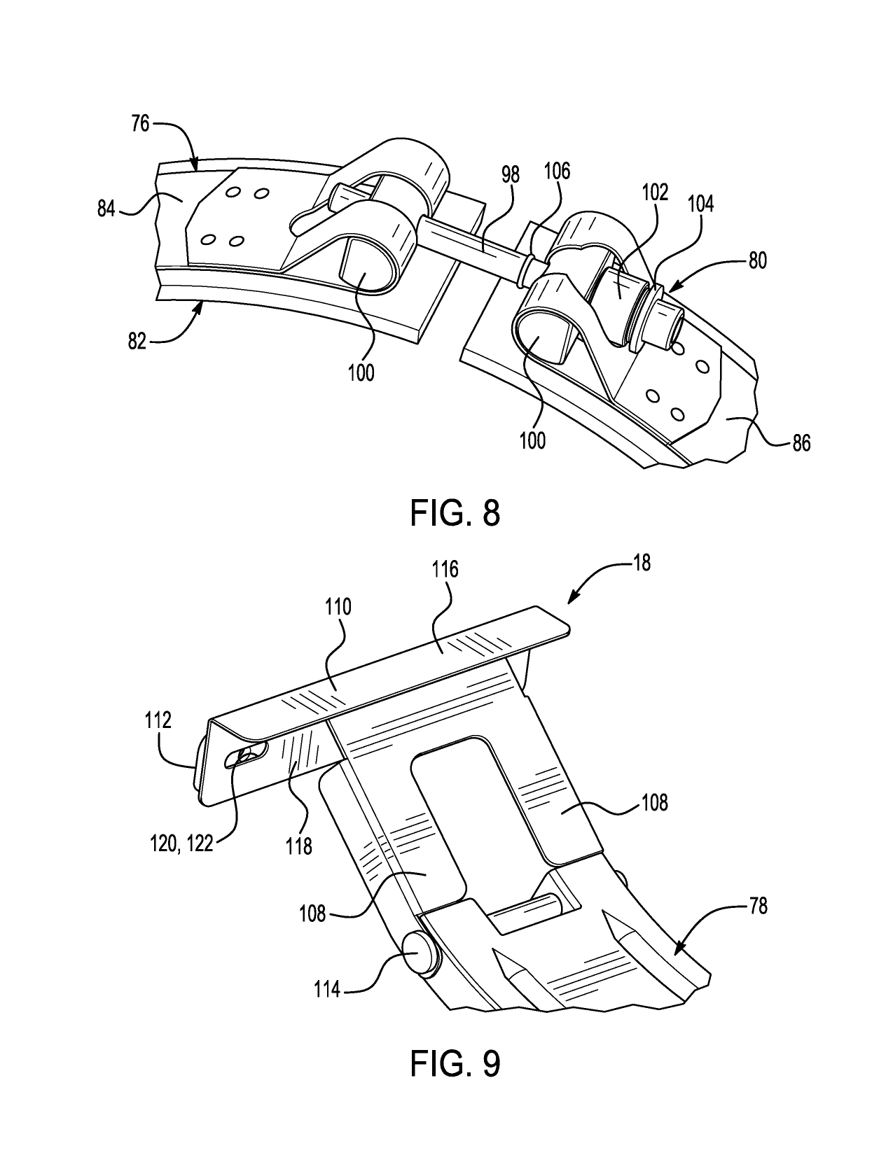

Referring now to FIGS. 5, 7, and 8, the tightening mechanism 80 is situated at the band 76 — in this embodiment, situated at the first and second band segments 84, 86 — and is used for tightening and loosening the tank strap assembly 10 and for tightening and loosening the first and second band segments 84, 86 about the alternative fuel tanks 16, 22. The tightening mechanism 80 can have various designs, constructions, and components in various embodiments. According to this embodiment, and as before, the tightening mechanism 80 has a bolt 98, a pair of convex bars 100, a spacer 102, spring washers 104, and an o-ring 106; still, in other embodiments the tightening mechanism could have more, less, and/or different components. Yet further, the elastic pad 82 is located radially inwardly of the band 76 and first and second band segments 84, 86, and located radially inwardly of the band bracket 78. Since the elastic pad 82 is compressible in nature, it can accommodate and account for the physical expansion of the alternative fuel tanks 16, 22 in the lateral direction and radial direction via compression and absorption.

The slidable bracket 18 can have various designs, constructions, and components in various embodiments. With reference now to FIGS. 5, 7, and 9-11, in this embodiment the slidable bracket 18 is mounted to the tank frame 14 and is particularly mounted to the horizontally-arranged working frame bars 28. The mounting enables slidable movement of the slidable bracket 18 and ultimately of the tank strap assembly 10 in the longitudinal direction A and with respect to the tank frame 14 and with respect to the working frame bars 28, and enables slidable movement in the axial direction with respect to the longitudinal and lengthwise axis of the alternative fuel tanks 16, 22. The slidable movement constitutes a single and sole degree of freedom (DoF) of the slidable bracket 18 and the tank frame 14 with respect to each other, per this embodiment. The single and sole DoF is a single and sole translational DoF established between the slidable bracket 18 and the tank frame 14. Providing the mounting and slidable movement can be carried out in various ways.

The slidable bracket 18 is composed of a metal material. In this embodiment, the slidable bracket 18 has a pair of bracket legs 108, a mount wall 110, and a mount plate 112. The bracket legs 108 and mount wall 110 make-up a unitary construction of the slidable bracket 18, while the mount plate 112 is a discrete component thereof that is brought together in assembly with the mount wall 110, as set forth below. The bracket legs 108 have a connection with the band bracket 78. The connection coincides with the second connection established between the second band segment 86 and the band bracket 78. The connection can take different forms in different embodiments. In this embodiment, a pin 114 extends through openings in the bracket legs 108 and extends through openings in the band bracket 78, establishing the connection therebetween. The pin 114 is a shared component and is employed for the second connection too and extends through the accompanying looped end of the second band segment 86. The pin 114 can be in the form of a bolt, as an example. The slidable bracket 18 can pivot about the pin 114 with respect to the band bracket 78.

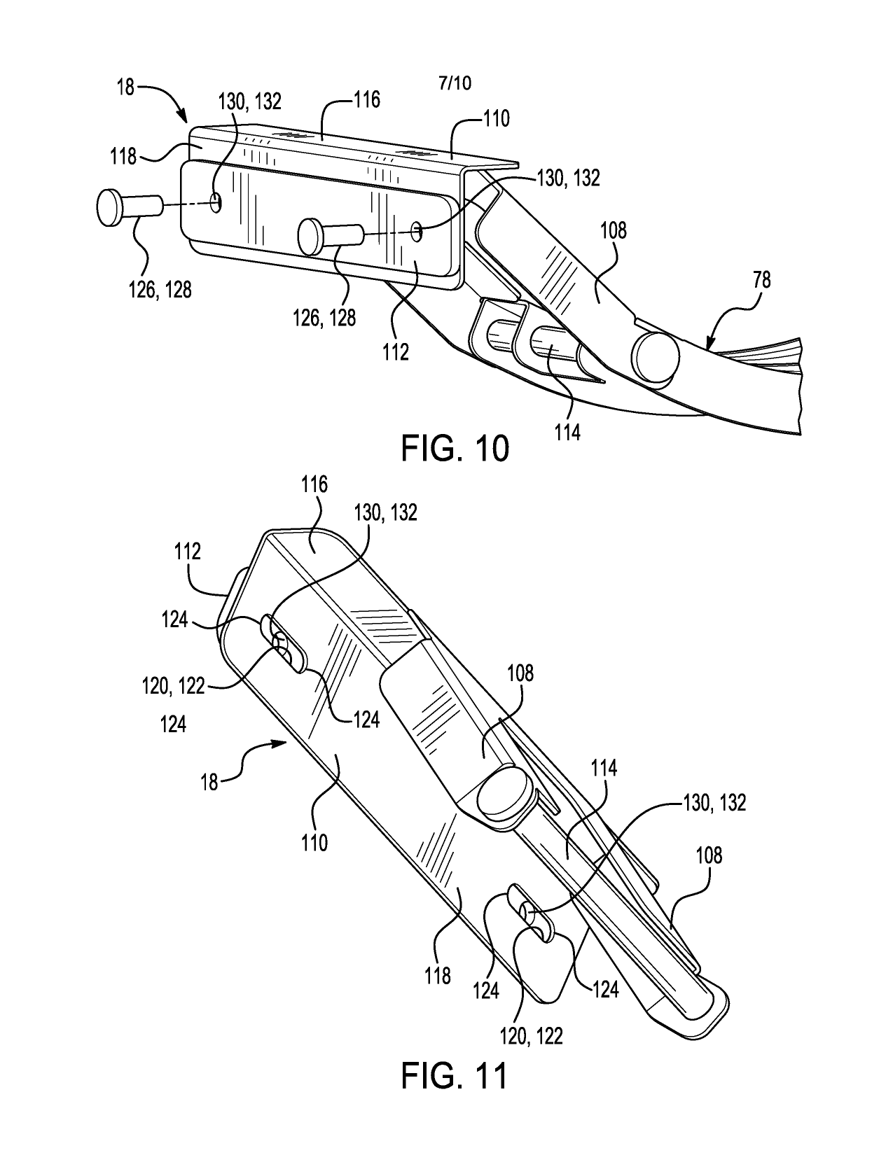

The mount wall 110 has a shape and construction to partially complement that of the working frame bars 28 for surface-to-surface placement therebetween. In this embodiment, the mount wall 110 has a first wall 116 and a second wall 118 that are orthogonally-configured relative to each other in order to correspond with confronting walls of the working frame bars 28. The mount wall 110 is placed on top of the working frame bars 28 in assembly and installation, as shown in FIG. 5. A pair of wall openings 120 in the form of a pair of slots 122 reside in the mount wall 110 and particularly in the second wall 118; still, other quantities and locations of the openings/slots are possible in other embodiments. In this embodiment, and with particular reference now to FIGS. 9 and 11, the slots 122 have elongated oval shapes with their major axes of greatest extent generally in-line the longitudinal direction A. Side surfaces 124 partly bound and define the slots 122. The slots 122 are spaced apart from each other on opposite sides of the mount wall 110. In assembly and installation, the slots 122 receive insertion of extensions 126 (FIG. 10) in the form of bolts 128. The bolts 128 are received through the slots 122 and into openings in the working frame bars 28. The bolts 128 are fixed in the openings in the working frame bars 28 and unable to move in the longitudinal direction A with respect thereto, as well as in other directions. The slot-and-bolt reception and insertion serves to provide guided slidable movement of the slidable bracket 18 with respect to the tank frame 14 in the longitudinal direction A. The location of the bolts 128 within the slots 122, and relative thereto, changes side-to-side as the slidable bracket 18 and mount wall 110 slidably moves in the longitudinal direction A. The slidable bracket 18 and mount wall 110 are able to move side-to-side relative to the bolts 128. Moreover, abutment between the side surfaces 124 of the slots 122 and the bolts 128 serves to constrain and restrict slidable movement of the slidable bracket 18 with respect to the tank frame 14 in the longitudinal direction A.

Furthermore, the mount plate 112 has a shape and construction to partially complement that of the second wall 118 of the mount wall 110 for surface-to-surface confrontation therebetween. The mount plate 112 is composed of a metal material and has a generally planar configuration. In this embodiment, a pair of wall openings 130 in the form of a pair of holes 132 reside in the mount plate 112; still, other locations and quantities of the openings/slots are possible in other embodiments. In this embodiment, and as perhaps shown best in FIGS. 10 and 11, the holes 132 have circular shapes to match that of the bolts 128. As evident from the figures, the holes 132 are generally lined-up with the slots 122 and smaller in overall size. The holes 132 are spaced apart from each other on opposite sides of the mount plate 112. In assembly and installation, the bolts 128 are inserted and received through the holes 132, through the slots 122, and into the openings in the working frame bars 28. The bolts 128 fix and constrain movement of the mount plate 112 and working frame bars 28 relative to each other. The mount plate 112 does not move with respect to the working frame bars 28, and does not move about the bolts 128. The mount plate 112 remains static as the slidable bracket 18 moves in the longitudinal direction A. The mount plate 112 is held in close position with the mount wall 110 and in confrontation with the second wall 118, while still permitting and enabling slidable movement of the mount wall 110 in the longitudinal direction A and with respect to the mount plate 112 and with respect to the working frame bars 28. The mount plate 112 does not substantially interfere with such slidable movement.

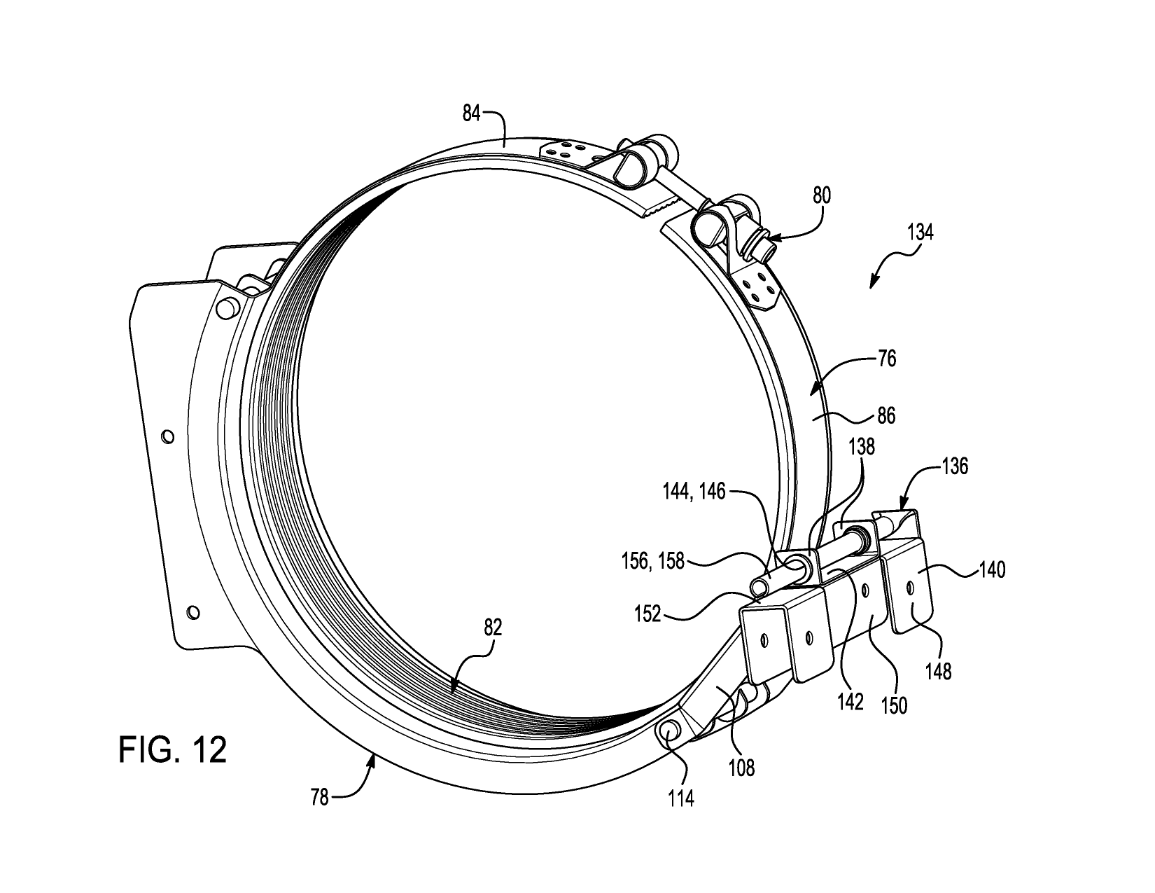

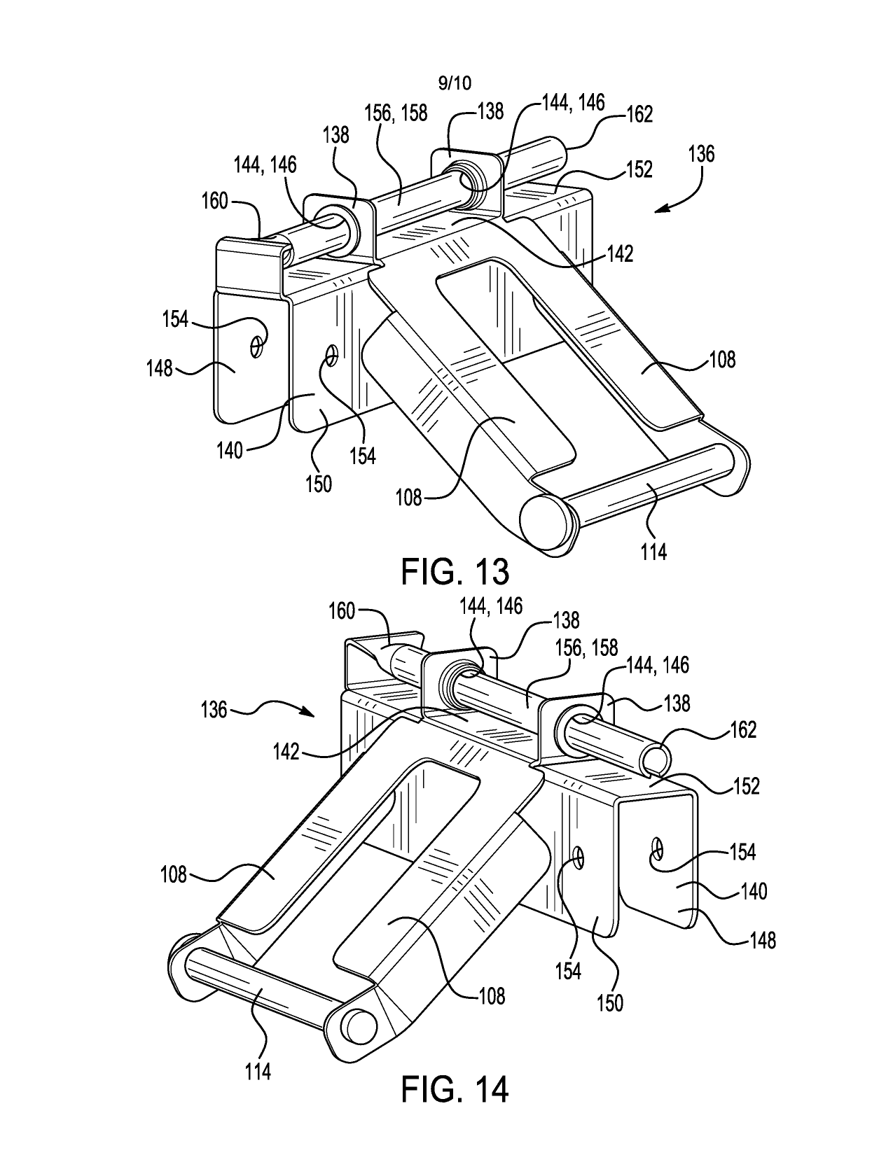

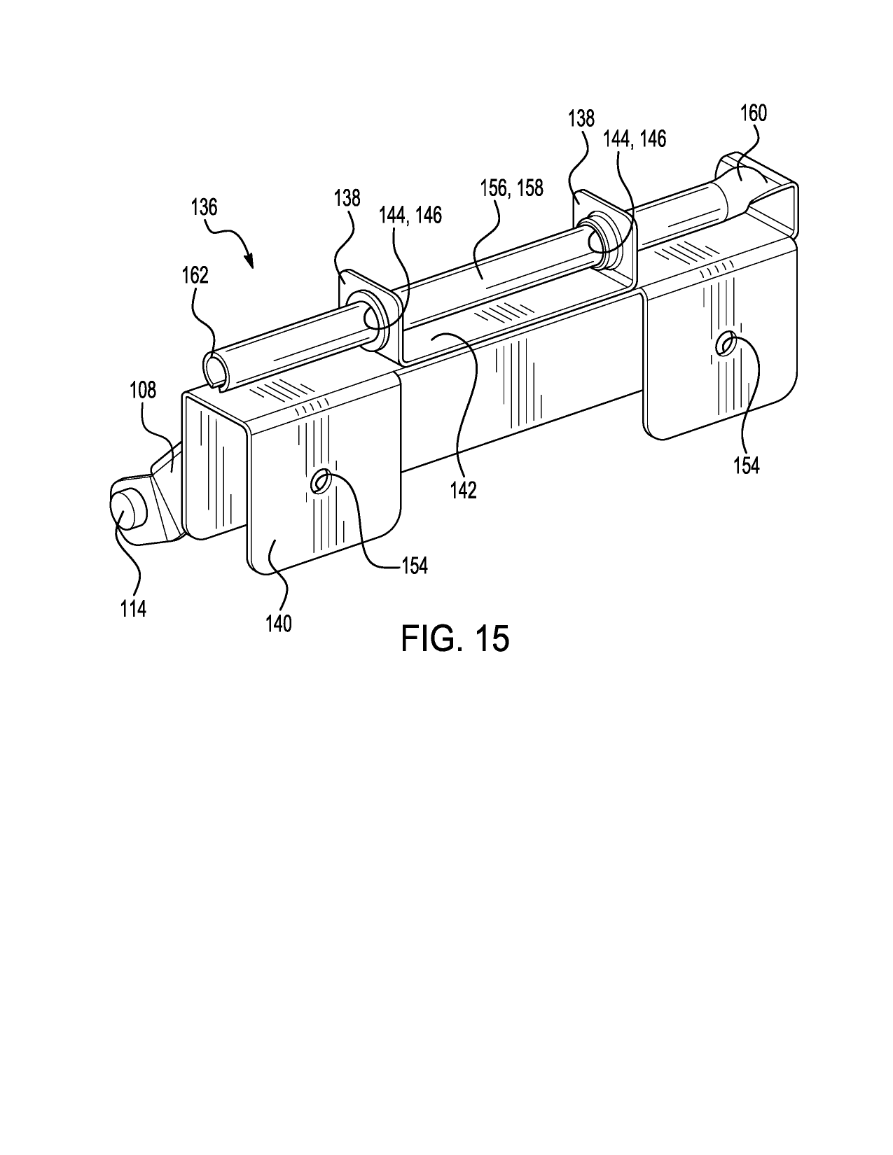

Turning now to FIGS. 12–15, a second embodiment of a tank strap assembly 134 is presented. Corresponding components and elements with this second embodiment and the previous embodiment have similar reference numerals in FIGS. 12–15, and the previous descriptions of these corresponding components and elements are equally applicable here for the second embodiment although they may not be wholly repeated. The tank strap assembly 134 can have various designs, constructions, and components in various embodiments. In the second embodiment, the tank strap assembly 134 includes the band 76, the band bracket 78, the tightening mechanism 80, the elastic pad 82, and a slidable bracket 136. The slidable bracket 136 has dissimilarities in the second embodiment from that of the previous embodiment.

The slidable bracket 136 can have various designs, constructions, and components in various embodiments. In the second embodiment, the slidable bracket 136 is mounted to the tank frame 14 and is particularly mounted to the horizontally-arranged working frame bars 28. The mounting enables slidable movement of the slidable bracket 136 and ultimately of the tank strap assembly 10 in the longitudinal direction A and with respect to the tank frame 14 and with respect to the working frame bars 28, and enables slidable movement in the axial direction with respect to the longitudinal and lengthwise axis of the alternative fuel tanks 16, 22. The slidable movement constitutes a single and sole degree of freedom (DoF) of the slidable bracket 136 and the tank frame 14 with respect to each other, per this embodiment. The single and sole DoF is a single and sole translational DoF established between the slidable bracket 136 and the tank frame 14. Providing the mounting and slidable movement can be carried out in various ways.

The slidable bracket 136 is composed of a metal material. In this embodiment, the slidable bracket 136 has the pair of bracket legs 108, a pair of bracket walls 138, and a mount base 140. The bracket legs 108 and bracket walls 138 make-up a unitary construction of the slidable bracket 136, while the mount base 140 is a discrete component thereof that is brought together in assembly with the bracket walls 138, as set forth below. The bracket legs 108 have a connection with the band bracket 78. As before, the connection coincides with the second connection established between the second band segment 86 and the band bracket 78. The connection can take different forms in different embodiments. In the second embodiment too, the pin 114 extends through openings in the bracket legs 108 and extends through openings in the band bracket 78, establishing the connection therebetween. The slidable bracket 136 can pivot about the pin 114 with respect to the band bracket 78.

The bracket walls 138 can have other quantities in other embodiments; for example, there could be a single bracket wall or more than two bracket walls. The bracket walls 138 are unitary constructions of a bracket base wall 142 which itself is a unitary construction of the bracket legs 108. The bracket base wall 142 has a shape and construction to partially complement that of the mount base 140 for surface-to-surface placement therebetween. The bracket base wall 142 has a generally planar configuration. The bracket base wall 142 is placed on top of the mount base 140 in assembly and installation. The bracket walls 138 extend orthogonally from the bracket base wall 142 and project upwardly therefrom. The bracket walls 138 are spaced apart from each other on opposite sides of the bracket base wall 142. A pair of wall openings 144 in the form of a pair of pass-throughs 146 reside in the bracket walls 138 — a single pass-through 146 is located in each bracket wall 138. In assembly and installation, the pass-throughs 146 receive insertion of an extension (introduced below) of the mount base 140.

Further, the mount base 140 has a shape and construction to partially complement that of the working frame bars 28 for surface-to-surface placement therebetween. The mount base 140 is composed of a metal material. In the second embodiment, the mount base 140 is generally made-up of three walls orthogonally-configured with respect to each other in order to correspond with confront walls of the working frame bars 28 — a first or front wall 148, a second or back wall 150, and a third or top wall 152. The first, second, and third walls 148, 150, and 152 have generally planar configurations. The mount base 140 is placed on top of the working frame bars 28 in assembly and installation. In the second embodiment, a pair of holes 154 reside in each of the first and second walls 148, 150; still, other locations and quantities are possible in other embodiments. The holes 154 have circular shapes to match that of bolts inserted and received therethrough. In assembly and installation, the bolts are inserted and received through the holes 154 and into openings in the working frame bars 28. The bolts fix and constrain movement of the mount base 140 and working frame bars 28 relative to each other. The mount base 140 does not move with respect to the working frame bars 28, and does not move about the bolts. The mount base 140 remains static as the slidable bracket 136 moves in the longitudinal direction A.

Yet further, an extension 156 in the form of a slide bar 158 is inserted and received through the pass-throughs 146 of the bracket walls 138 in assembly of the slidable bracket 136. The slide bar 158 is part of the mount base 140. The slide bar 158 extends from a proximal end 160 to a distal, free end 162. A longitudinal and lengthwise axis and extent of the slide bar 158 is generally in-line the longitudinal direction A. The slide bar 158 and pass-through 146 reception and insertion serves to provide guided slidable movement of the slidable bracket 136 with respect to the tank frame 14 in the longitudinal direction A. Amid use of the tank strap assembly 134, the slidable bracket 136 and its bracket walls 138 are able to slidably move in the longitudinal direction A along a section of the slide bar 158 and thereabout, and with respect to the mount base140 and slide bar 158.

In general, while a multitude of embodiments have been depicted and described with a multitude of components and steps in each embodiment, in alternative embodiments the components and steps of various embodiments could be intermixed, combined, and/or exchanged for one another. In other words, components described in connection with a particular embodiment are not necessarily exclusive to that particular embodiment.

As used herein, the terms “general” and “generally” and “substantially” and “approximately” and their grammatical variations are intended to account for the inherent degree of variance and imprecision that is often attributed to, and often accompanies, any design and manufacturing process, including engineering tolerances — and without deviation from the relevant functionality and intended outcome — such that mathematical precision and exactitude is not implied and, in some instances, is not possible. In other instances, the terms “general” and “generally” and “substantially” and “approximately” and their grammatical variations are intended to represent the inherent degree of uncertainty that is often attributed to any quantitative comparison, value, and measurement calculation, or other representation.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

What is claimed is:

1. A tank strap assembly, comprising:
a band;
a band bracket mountable to a tank frame and connected with said band;
a tightening mechanism situated at said band for tightening of the tank strap assembly, said tightening mechanism comprising a bolt; and
a slidable bracket connected with said band bracket, said slidable bracket mountable to the tank frame and moveable in a longitudinal direction with respect to the tank frame.

2. The tank strap assembly as set forth in claim 1, wherein said band includes a first band segment and a second band segment, said band bracket is connected with said first band segment and is connected with said second band segment, and said tightening mechanism is situated between said first band segment and said second band segment.

3. The tank strap assembly as set forth in claim 1, further comprising an elastic pad located inwardly of said band and of said band bracket.

4. The tank strap assembly as set forth in claim 1, wherein said slidable bracket comprises at least one wall opening and an extension received in said at least one wall opening, said at least one wall opening and said extension providing guided slidable movement of said slidable bracket with respect to the tank frame in the longitudinal direction.

5. The tank strap assembly as set forth in claim 1, wherein said slidable bracket establishes a single degree of freedom (DoF) with respect to the tank frame, said single degree of freedom being a single translational degree of freedom in the longitudinal direction.

6. The tank strap assembly as set forth in claim 1, wherein said slidable bracket comprises at least one opening residing in a wall and defined at least in part by a side surface, abutment between an extension and said side surface providing a restriction on slidable movement of said slidable bracket with respect to the tank frame in the longitudinal direction.

7. The tank strap assembly as set forth in claim 1, wherein said band bracket is moveable in the longitudinal direction with respect to the tank frame.

8. The tank strap assembly as set forth in claim 1, wherein said slidable bracket is pivotable with respect to said band bracket at the connection with said band bracket.

9. The tank strap assembly as set forth in claim 1, wherein said slidable bracket comprises a mount plate and a mount wall, said mount plate having at least one hole and said mount wall having at least one slot, a bolt extends through said at least one hole and through said at least one slot, said mount wall moveable in the longitudinal direction with respect to said mount plate via the bolt and via said at least one hole and via said at least one slot.

10. The tank strap assembly as set forth in claim 1, wherein said slidable bracket comprises at least one bracket wall with at least one pass-through residing therein, said slidable bracket further comprising a mount base, said mount base having a slide bar that is received through said at least one pass-through, said bracket wall moveable in the longitudinal direction with respect to said mount base via receipt of said slide bar through said at least one pass-through.

11. A tank frame assembly comprising the tank strap assembly of claim 1 and the tank frame, and further comprising a second tank strap assembly having a second band, a second band bracket mounted to the tank frame, a second tightening mechanism, and a non-slidable bracket mounted to the tank frame.

12. A tank strap assembly, comprising:
a band;
a band bracket mountable to a tank frame and connected with said band and moveable in a longitudinal direction with respect to the tank frame;
a tightening mechanism situated at said band for tightening of the tank strap assembly, said tightening mechanism comprising a bolt; and
a slidable bracket moveable in the longitudinal direction with respect to the tank frame via at least one wall opening and via an extension received in said at least one wall opening, said at least one wall opening and said extension providing guided slidable movement of said slidable bracket with respect to the tank frame in the longitudinal direction.

13. The tank strap assembly as set forth in claim 12, wherein said slidable bracket has a pivotable connection with said band bracket.

14. The tank strap assembly as set forth in claim 12, further comprising an elastic pad located inwardly of said band and inwardly of said band bracket, and wherein said band includes a first band segment and a second band segment.

15. The tank strap assembly as set forth in claim 12, wherein said slidable bracket establishes a single degree of freedom (DoF) with respect to the tank frame, said single degree of freedom being in the longitudinal direction.

16. The tank strap assembly as set forth in claim 12, wherein said slidable bracket comprises a mount wall, said at least one wall opening residing in said mount wall and said at least one wall opening having side surfaces, abutment between said extension and said side surfaces restricting slidable movement of said slidable bracket with respect to the tank frame in the longitudinal direction.

17. The tank strap assembly as set forth in claim 16, wherein said slidable bracket comprises a mount plate, said mount plate having at least one hole, said extension received in said at least one hole, said mount plate remaining static with respect to the tank frame upon slidable movement of said slidable bracket with respect to the tank frame in the longitudinal direction.

18. The tank strap assembly as set forth in claim 12, wherein said slidable bracket comprises at least one bracket wall, said at least one wall opening residing in said at least one bracket wall, said extension remaining static with respect to the tank frame upon slidable movement of said slidable bracket with respect to the tank frame in the longitudinal direction.

19. The tank strap assembly as set forth in claim 18, wherein said slidable bracket comprises a mount base mountable to the tank frame, said extension extending from said mount base, said mount base remaining static with respect to the tank frame upon slidable movement of said slidable bracket with respect to the tank frame in the longitudinal direction.

20. A tank strap assembly, comprising:
a first band segment and a second band segment;
a band bracket mountable to a tank frame and connected with said first band segment and connected with said second band segment;
a tightening mechanism situated between said first band segment and said second band segment, said tightening mechanism comprising a bolt;
an elastic pad located inwardly of said first and second band segments and inwardly of said band bracket; and
a slidable bracket connected with said band bracket and mountable to the tank frame, said slidable bracket comprising a mount plate and a mount wall, said mount plate having at least one hole and said mount wall having at least one slot, a bolt extending through said at least one hole and through said at least one slot, said mount wall slidably moveable in a longitudinal direction with respect to the tank frame and with respect to said mount plate.
